(19) United States
(12) Patent Application Publication
(10) Pub. No.: US 2008/0181176 A1
(43) Pub. Date: Jul. 31, 2008

(54) FRAMEWORK TO DESIGN NEW MAC MESSAGE EXCHANGE PROCEDURE RELATED TO MOBILE STATION (MS) HANDOVER IN MULTI-HOP RELAY BROADBAND WIRELESS ACCESS NETWORK

(76) Inventors: Hyunjeong Lee, Hillsboro, OR (US); Wendy C. Wong, San Jose, CA (US); Jaroslaw J. Sydir, San Jose, CA (US); Kerstin Johnsson, Palo Alto, CA (US)

Correspondence Address: INTEL CORPORATION;c/o INTELLEVATE, LLC, P.O. BOX 52050, MINNEAPOLIS, MN, 55402, US

(21) Appl. No.: 11/923,551

(22) Filed: Oct. 24, 2007

Related U.S. Application Data
(60) Provisional application No. 60/855,696, filed on Oct. 30, 2006.

(51) Int. Cl. H04Q 7/00

(52) U.S. Cl. 370/331

(57) ABSTRACT

A protocol framework for MS handover in MR networks includes new messages and an optimized flow of these messages. A framework for use in a multi-hop topology of MR networks optimizes the handover performance. The framework is applicable and expandable to the design of a new control message exchange procedure for MS handover.

The present application claims priority to U.S. Patent Application No. 60/855,696, filed Oct. 30, 2006, entitled “Framework to Design New Mac Message Exchange Procedure Related to Mobile Station (Ms) Handover in Multi-Hop Relay Broadband Wireless Access Network,” the entire disclosure of which is hereby incorporated by reference in its entirety.

Developments in a number of different digital technologies have greatly increased the need to transfer data from one device across a network to another system. Technological developments permit digitization and compression of large amounts of voice, video, imaging, and data information, which may be transmitted from laptops and other digital equipment to other devices within the network. These developments in digital technology have stimulated a need to deliver and supply data to these processing units.

It is becoming increasingly attractive to use wireless nodes in a wireless network as relaying points to extend range and/or reduce costs of a wireless network. A Multi-hop Relay (MR) network may use fixed and/or mobile stations as relaying points to optimize communications and increase the efficiency of transmissions. One notable issue is how to coordinate the selection of optimal transmission paths using new protocols and architectures and reduce costs associated with these networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an arrangement of wireless nodes in an example wireless network for conveying multi-hop link information according to one embodiment of the present invention;

FIG. 2 is a diagram for seven different handover cases in the embodiment described for the Multi-hop Relay (MR) network comprised of two macro cells; and

FIGS. 3-7 illustrate direct communication paths and control message exchanges for handover in six cases denoted as CASE 1; CASE 2; CASE 3; CASE 5; CASE 6 and CASE 7.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Wireless multi-hop relay systems have become the focus of several current standardization efforts. For example, for WLANs the Institute of Electrical and Electronics Engineers (IEEE) 802.11s Mesh Task Group (TG) is actively working on standard solutions for WLAN mesh networking. Additionally, the IEEE 802.16j Multi-hop Relay (MR) task group is also evaluating solutions for standardization in furtherance of the IEEE 802.16j project approval request for wireless broadband access (WBA) networks.

The multi-hop relay systems provide a cost effective way for multi-media traffic to increase in range. The Relay Stations (RSs) offer extended coverage through existing networks and the MR system is a cost effective solution accommodating many mobile subscribers, establishing wide area coverage and providing higher data rates. Thus, the multi-hop relay systems enhance throughput and capacity for 802.16 systems and enable rapid deployment which reduces the cost of system operation.

MR relay stations are intended to be fully backward compatible in the sense that they should operate seamlessly with existing 802.16e subscriber stations. A further phase of 802.16 is expected to introduce enhanced relay and WBA subscriber stations designed for use in MR networks. While the embodiments discussed herein may refer to 802.16 wireless broadband access networks, sometimes referred to as WiMAX, an acronym that stands for Worldwide Interoperability for Microwave Access, which is a certification mark for products that pass conformity and interoperability tests for the IEEE 802.16 standards, they are not so limited and may be applicable to WLAN, other types of mesh networks or even combinations of different networks. Multi-hop relay techniques may be applied to other emerging standards such as 3rd Generation Partnership Project (3GPP) for the Long Term Evolution (LTE).

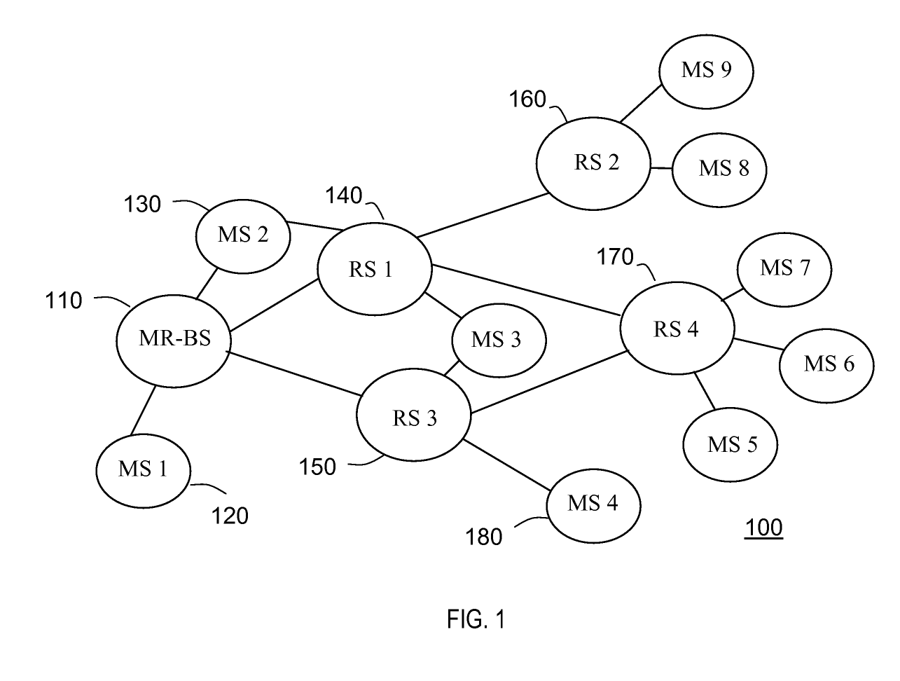

FIG. 1 is a diagram illustrating an arrangement of wireless nodes in an example wireless network for conveying multi-hop link information according to one embodiment of the present invention. A Multi-hop Relay (MR) network 100 may be any system that introduces relay stations (RSs) between IEEE 802.16/16e compliant mobile stations (MSs) and base stations (MR-BSs) capable of transmitting and/or receiving information via at least some Over-The-Air (OTA) Radio Frequency (RF) links. For example in one embodiment, the topology of MR network 100 may include an MR Base Station (MR-BS) 110 that provides direct access to multiple Mobile Stations (MSs) 120 and 130. MR-Base Station 110 also connects to a plurality of unwired relay nodes shown as Relay Stations (RS) 140 and 150 in the figure. RSs relay data between MR-BS 110 and MSs via a multi-hop relay path. Multiple paths may be supported in order to provide redundancy and traffic load balancing.

Relay Stations (RSs) 140 and 150 wirelessly communicate and relay messages in MR network 100 using wireless protocols and/or techniques compatible with one or more of the various 802 wireless standards for WPANs and/or standards for WMANs, although the inventive embodiments are not limited in this respect. As illustrated in the figure, Relay Stations (RSs) 140 and 150 provide access to Mobile Stations 130 and 180 as well as relay data on behalf of other RSs. In certain non-limiting example implementations of the inventive embodiments, the topology illustrated is mesh like to provide multiple communication paths or links. Access links support direct communication paths between a MR-BS and MSs such as, for example, the link between MR-BS 110 and mobile station 120 or between an RS and MSs such as, for example, the link between RS 140 and mobile station 130. Relay links support direct communication paths between a MR-BS and RSs such as, for example, the link between MR-BS 110 and Relay Station 140.

MR network 100 utilizes a frame structure which allows multiple relay links to share a channel, and thus, multiple PMP links may be supported on the same channel. When multiple PMP links share a channel, the stations that participate in the links synchronize and data is transmitted to minimize interference. The frame structure is configurable to optimize the topology and the requirements for deployment and allow the multiple PMP links to share the channel while utilizing a combination of time division multiplexing (TDM) and spatial reuse.

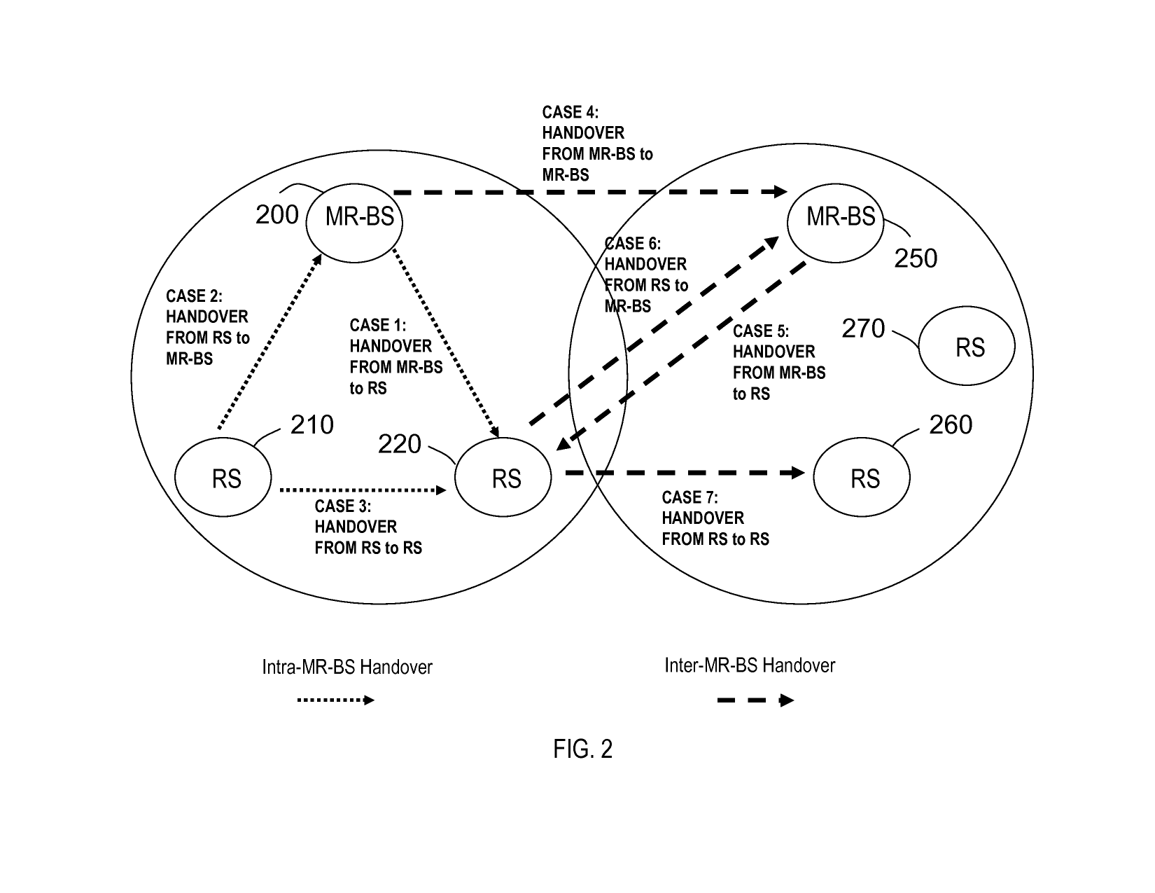

FIG. 2 is an example of a Multi-hop Relay (MR) network 100 comprised of two macro cells, each of which may generally be comprised of one base station and a plurality of relay stations RSs dispersed throughout each macro cell and working in combination with the base station(s) to provide a full range of coverage to client stations. In the example embodiment shown in the figure, there may be k-hop (k>1) relay paths between the MR-BS and the RSs such as, for example, the k-hop relay link between MR-BS 200 and Relay Station 210 and the k-hop relay path between MR-BS 200 and Relay Station 220. The multi-hop topology between the MR-BS and RSs may be viewed as a Point-to-Multipoint (PMP) link. Each PMP link relies on the stations to maintain time and frequency synchronization that is performed via the broadcast and reception of a downlink (DL) preamble, whereas uplink (UL) synchronization is performed by a ranging process.

FIG. 2 further illustrates seven different handover cases in the embodiment described b MR network 100. The seven handover cases may be separated into two main handover categories. The first category involves handover between two RSs controlled by the same MR-BS or between an MR-BS and one of its subordinate RSs. This first category for handover is denoted as an Intra MR-BS handover. The second category involves handover between two RSs each controlled by different MR-BSs or between an MR-BS and an RS controlled by a different MR-BS. This second category for handover is denoted as an Inter MR-BS handover. There may be two to four infrastructure stations directly involved with an MS handover by counting access and serving stations but not intermediate RSs. Note that this does not include optional handover features such as, for example, Macro Diversity Handover (MDHO) and Fast Base Station Switching (FBSS) in IEEE 802.16e-2005. Further note that the signaling between the stations (MR-BSs and RSs) occurs over the wireless links as well as over a wired backbone.

In the figure the first handover case is labeled CASE 1 and illustrates handover from MR-BS 200 to RS 220. The second handover case (labeled CASE 2) illustrates handover from RS 210 to MR-BS 200. The third handover case (labeled CASE 3) illustrates handover from RS 210 to RS 220. As previously described, CASE 1, CASE 2, and CASE 3 are in the first category denoted as the Intra MR-BS handoff. The fourth handover case (labeled CASE 4) illustrates handover from MR-BS 200 to MR-BS 250. The fifth handover case (labeled CASE 5) illustrates handover from MR-BS 250 to RS 220. The sixth handover case (labeled CASE 6) illustrates handover from RS 220 to MR-BS 250. The seventh handover case shown in the figure (labeled CASE 7) illustrates handover from RS 220 to RS 260. Also as previously described, CASE 4, CASE 5, CASE 6 and CASE 7 are in the second category denoted as the Inter MR-BS handover.

Only two infrastructure stations are involved with an MS handover for CASE 1, CASE 2 and CASE 4. On the other hand, three infrastructure stations are involved for CASE 3, with RS 210 as the current access station, RS 220 as the target access station, and MR-BS 200 as the serving station. MR-BS 200 remains as the serving station after the handover. Likewise, three infrastructure stations are involved for CASE 5 with MR-BS 250 as the current serving and access station, RS 220 as the target access station, and MR-BS 200 as the target serving station. The three infrastructure stations involved for CASE 6 include MR-BS 200 as the current serving MR-BS, RS 220 as the current access station, and MR-BS 250 as the target serving and access station. Finally, there are four stations involved for CASE 7 that include MR-BS 200 as the current serving station, RS 220 as the current access station, MR-BS 250 as the target serving station and RS 260 as the target access station.

It is pointed out that the handover protocol defined in IEEE 802.16e may be used to support MS handover between two MR-BSs which is found in handover CASE 4. However, the other six cases, namely CASE 1, CASE 2, CASE 3, CASE 5, CASE 6 and CASE 7 are not covered in IEEE 802.16e and these cases are in need of new control messages. Further, the corresponding signaling procedure for RSs and MR-BSs for these particular cases needs to be defined to support a seamless handover of an IEEE 802.16e compliant MS. Accordingly, in accordance with the present invention, a protocol for infrastructure stations (i.e., MR-BSs and RSs) is provided to support the handover cases defined by CASE 1, CASE 2, CASE 3, CASE 5, CASE 6 and CASE 7.

The new protocol includes new messages and an optimized flow of these messages between the infrastructure stations. The infrastructure stations in the MR network implement the new protocol to seamlessly support this handover. The new protocol framework applies to phases such as network topology advertisement, scanning for MS cell reselection, handover decision and initiation, and handover execution including network entry/re-entry and termination with the current access station. As a result, the new protocol provides a structured framework for exchanging control messages in each phase aiming at the correct protocol operation and handover performance optimization.

Table 1 defines the new signaling management messages over relay links in an 802.16j network and their functionality in relation to each phase of 802.16e MS MAC handover procedure. The message exchange between an MR-BSs and the RSs stations occurs over the wireless links as well as over the wired backbone in 802.16j network. When the messages are delivered over the wired backbone the format of the messages may change to the ones for wired backbone.

TABLE 1

| New control | | |
|---|---|---|
| messages | Related MS handover Phase | Functionality |
| ST_SCN-REQ, | MS scanning of neighbor | These messages are used to coordinate an association for an MS at target access |
| ST_SCN-RSP | stations | station(s). |
| HO_INFO-REQ, | Handover decision and initiation | These messages are used to pass the handover related information of potential |
| HO_INFO-RSP | | target access station(s) to the current access station. |
| MS_INFO-REQ/ | Handover execution | These messages are used to pass MS information to target (i.e., new) access and |
| MS_INFO-RSP | | target serving station(s) when the actual handover is performed between the target |
| | | access station and MS. |
| HO_CPL | Handover termination | This message is used to notify successful handover to the current access and |
| | | serving station(s) and to the target serving station. |

Table 2 lists MAC handover protocol for infrastructure stations and the possible source and destination pairs of each control message in the new protocol. In this table “S” denotes the source of the message and “D” denotes the destination of the message. The listed message exchanges denoted in Table 2 are selected for use depending on the co-located functionality within an infrastructure station, the available paths between infrastructure stations and the contents of the message. By way of example, if an MR-BS is both the current access and serving station (see CASE 1 and CASE 5) then the message exchange “1-2” listed in Table 2 is not used. Also by way of example, if an MR-BS is both the current and target serving station as in CASE 1, CASE 2, and CASE 3 (i.e., intra MR-BS handover), then the message exchange “1-3” listed in Table 2 is unnecessary.

TABLE 2

| | | Current | Current | Target | Target |
|---|---|---|---|---|---|
| | | Access | Serving | Access | Serving |
| Control Message | | Station | Station | Station | Station |
| ST_SCN-REQ, | (1-1) | S | | D | |
| HO_INFO-REQ, | (1-2) | S | D | | |
| MS_INFO-RSP | (1-3) | | S | | D |
| | (1-4) | | | D | S |
| ST_SCN-RSP, | (2-1) | D | | S | |
| HO_INFO-RSP, | (2-2) | | | S | D |
| MS_INFO-REQ, | (2-3) | | D | | S |
| HO_CP | (2-4) | D | S | | |

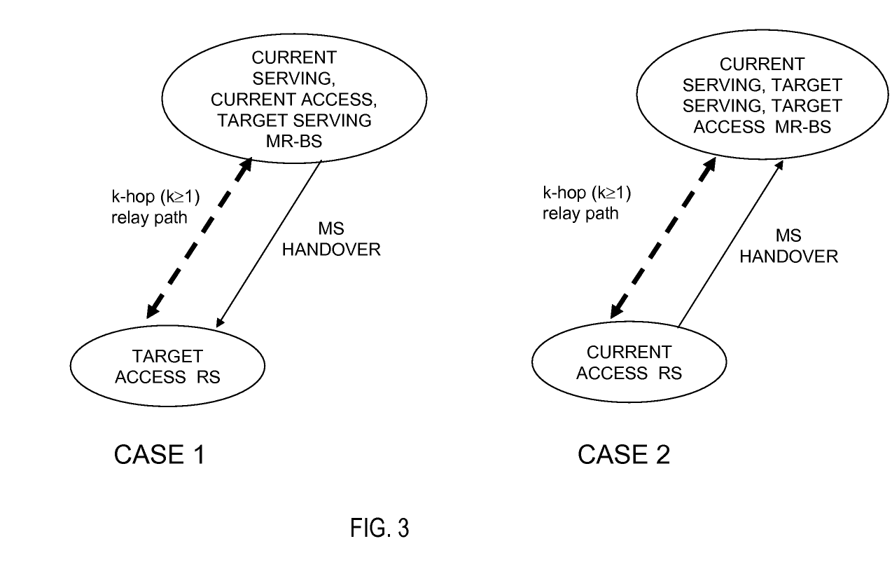

The protocol description for the six handover cases depicted in FIG. 1, namely CASE 1, CASE 2, CASE 3, CASE 5, CASE 6 and CASE 7 is further described with reference to FIGS. 3-7. In these figures, the solid arrowed lines denote the MS handover direction and the dotted arrowed lines denote the path for control message exchanges.

### CASE 1 and CASE 2

FIG. 3 illustrates direct communication paths and control message exchanges for handover CASE 1 between a current serving, current access, target serving MR-BS and a target access RS. The figure also illustrates control message exchanges for handover CASE 2 between a current serving, current access, target serving MR-BS and a current access RS. In this figure the two infrastructure stations involved in the MS handover are shown along with the k-hop relay paths between the stations. All of the new control messages are exchanged over the k-hop relay path.

### CASE 3

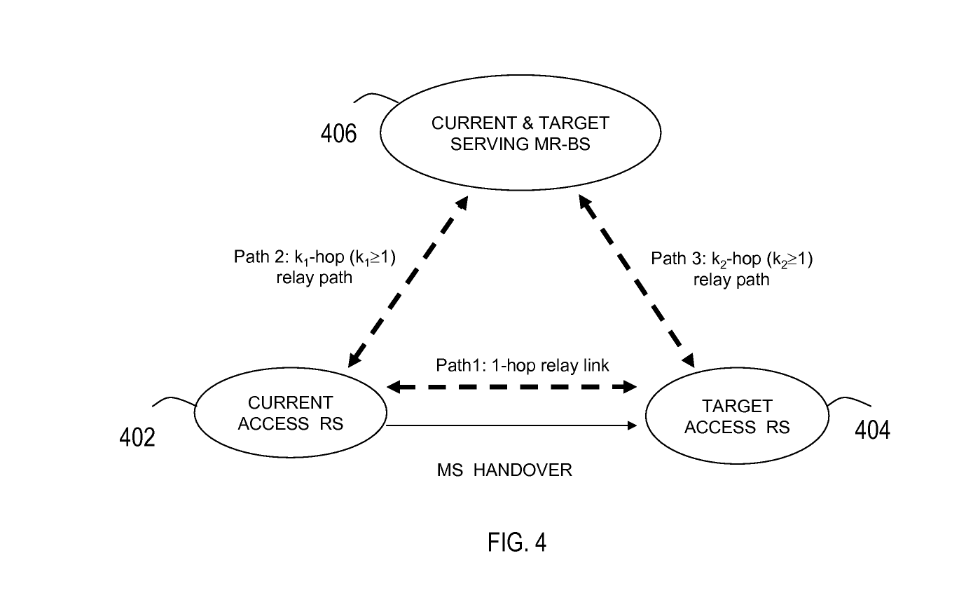

FIG. 4 illustrates control message exchanges for handover CASE 3, the exchanges being between RS 402 as the current access station and RS 404 as the target access station. In this MR network MR-BS 406 is the current and target serving station and RS 402 and RS 404 are its subordinates. If a direct 1-hop relay link exists between RS 402 and RS 404 (shown in the figure as Path 1), then control messages such as ST_SCN-REQ/ST_SCN-RSP, HO_INFO-REQ/HO_INFO-RSP, and MS_INFO-REQ/MS_INFO-RSP may be exchanged via this path. These control messages are shown in Table 2 as message “1-1” and message “2-1”. Note that the message “2-1” and the message “2-2” are selected for the HO_CPL message if Path 1 exists.

However, if the RSs are unable to set up Path 1 (i.e., direct 1-hop relay link between them), then the current access RS 402 and the target access RS 404 communicate via alternative paths. These alternative paths are shown in the figure as Path 2 and Path 3. With the alternative paths for communication in place the messages “1-2”, “1-4”, “2-2” and “2-4” described in TABLE 2 may be used. However, if Path 1 does not exist then HO_CPL is exchanged via Path 2 and Path 3 using message “2-2” and message “2-4”. When using Path 2 and Path 3, both the latency and overhead increase approximately (k₁+k₂) times compared to using Path 1. CASE 5 and CASE 6

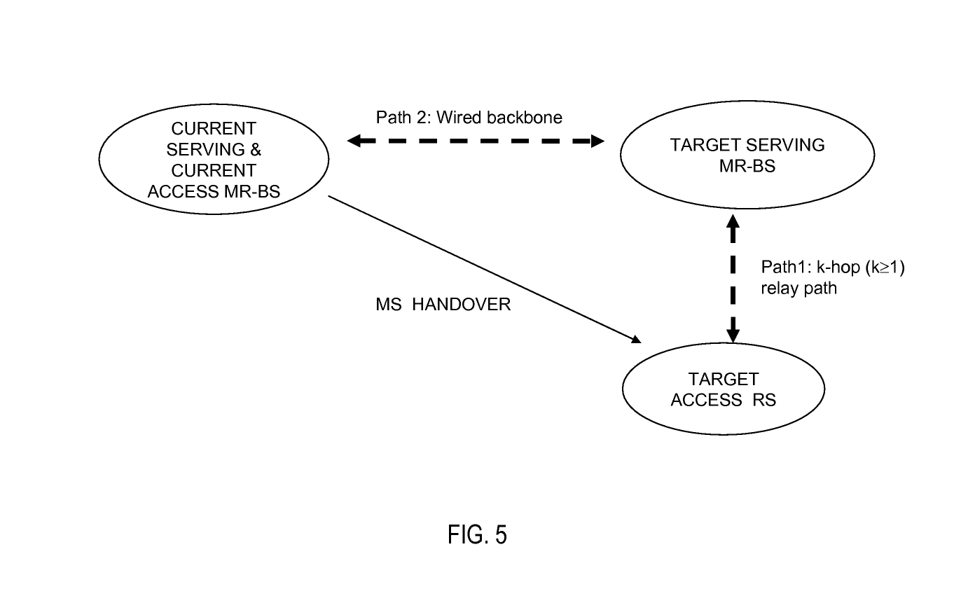

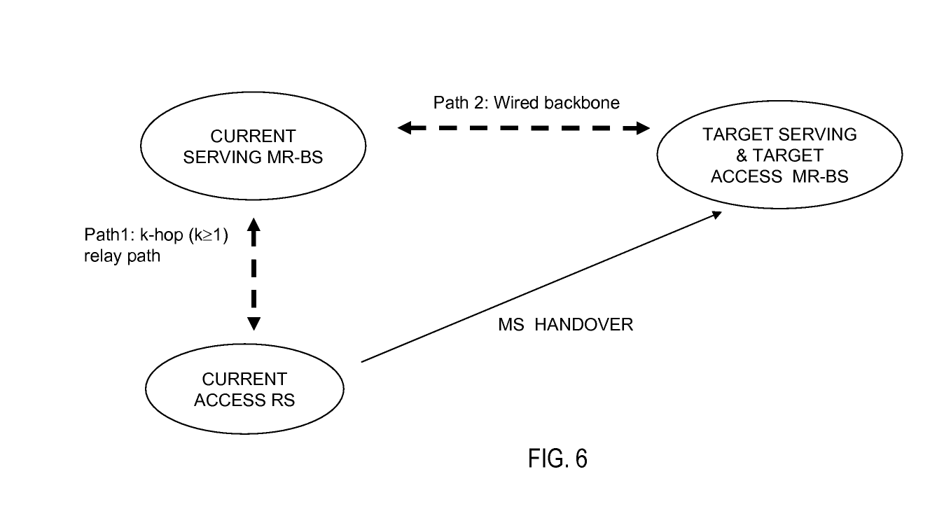

FIG. 5 illustrates control message exchanges for handover CASE 5 in which the MS handover is from an MR-BS to an RS in a different MR-cell. FIG. 6 illustrates control message exchanges for handover CASE 6 where the handover is from an RS to an MR-BS in a different MR-cell. In both CASE 5 and in CASE 6, all control messages are delivered using Path 1 (i.e., k-hop relay path) and Path 2 (i.e., wired backbone). Specifically, all the control messages including ST_SCN-REQ/RSP, HO_INFO-REQ/RSP, MS_INFO-REQ/RSP, and HO_CPL messages are exchanged along Path 1 and Path 2. Note that message “1-3”, message “1-4”, message “2-2”, and message “2-3” of Table 2 are selected for Case 5. Further note that message “1-2”, message “1-3”, message “2-3” and message “2-4” of Table 2 are selected for Case 6.

Alternatively, the multi-hop relay path may be established between the current serving/access MR-BS (the current access RS) and the target access RS (target serving/access MR-BS) together with Path-1 or Path-2. However, this incurs additional protocol overhead and latency to discover the relay path between them. In addition, it is very likely that the relay path cost between the target access RS (current access RS) and the current MR-BS (target MR-BS) is larger than the cost of Path 1 since the RS does not belong to the MR-cell of the target MR-BS. Therefore, using Path 1 and Path 2 can reduce the overhead as well as the associated delay.

### CASE 7

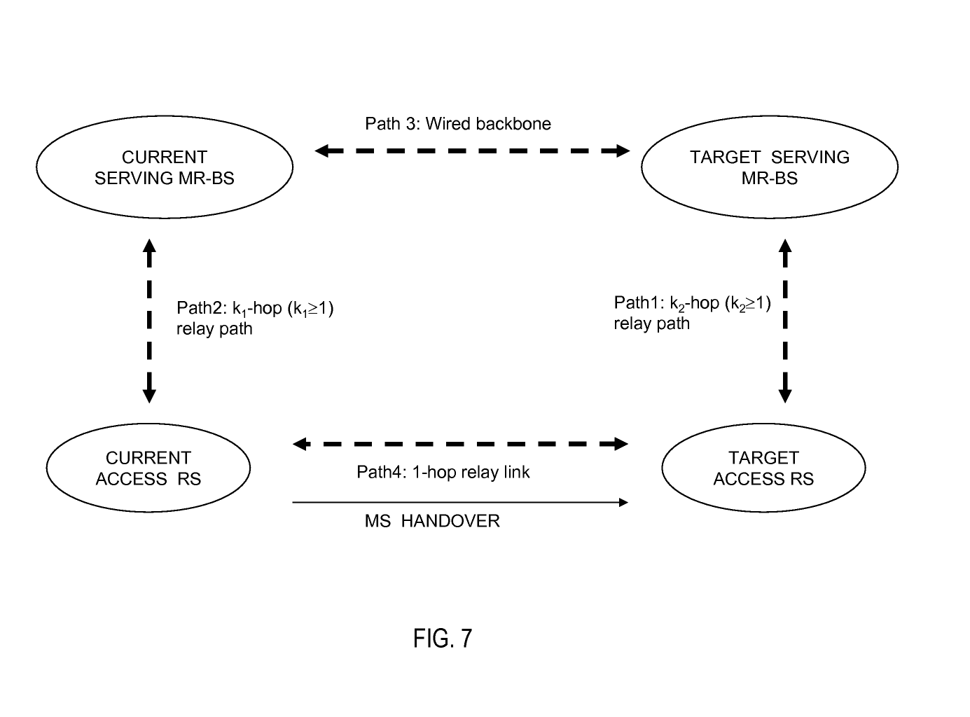

FIG. 7 illustrates control message exchanges for handover CASE 7 in which an MS handovers from an RS to another RS in a different MR-cell. Control messages including ST_SCN-REQ/RSP, HO_INFO-REQ/RSP are exchanged over Path 4 (i.e., 1-hop relay link) and message “1-1” and message “2-1” of Table 2 are chosen.

Alternatively, a path depicted in the figure as Path 1-Path-3-Path-2 may be used but the wireless resource consumption and delay of this combined path would be many times that of Path 4. It would also be possible to find a multi-hop path(s) between the current access RS and the target serving MR-BS and/or between the target access RS and the current serving MR-BS and then use the discovered path with Path 1 and/or Path 2, etc.

The control message exchange MS_INFO-REQ may be delivered using Path 4, Path 1, and Path 3. Note that message “2-1”, message “2-2”, message “2-3”, message “1-1”, and message “1-3” of Table 2 are selected. The control message exchange HO_CPL may be delivered using Path 4, Path 1, and Path 3 for message “2-1”, message “2-2”, and message “2-3” (see Table 2). Note that if Path 4 cannot be set up, message “1-2”, message “1-3”, message “1-4”, message “2-2”, message “2-3” and message “2-4” are selected and Path 1, Path 3, and Path 2 are used for all cases.

By now it should be apparent that a protocol framework for MS handover in MR networks has been presented that includes new messages and the optimized flow of these messages. In accordance with the present invention, a framework for use in a multi-hop topology of MR networks optimizes the handover performance. In addition, the framework is applicable and expandable to the design of a new control message exchange procedure for MS handover.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of defining communication protocol among infrastructure stations to support six Mobil Station (MS) handover cases in multi-hop wireless systems, comprising:
coordinating an MS scanning region between current and target infrastructure stations that are involved in MS handover;
requesting and receiving handover information between the current and target infrastructure stations that are involved in the MS handover;
requesting and receiving MS information between the current and target infrastructure stations that are involved in the MS handover; and
informing the infrastructure stations of MS handover completion at a target access station.

2. The method of claim 2, further comprising:
control message exchange flows and procedures for the six MS handover cases in the multi-hop wireless systems.

3. The method of claim 2, wherein the six Mobil Station (MS) handover cases include:
handover from MR-BS to RS;
handover from RS to MR-BS;
handover from RS to RS;
handover from MR-BS to MR-BS;
handover from MR-BS to RS; and
handover from RS to MR-BS.

4. A method for determining control message exchange flows in a multi-hop wireless system, comprising:
determining existing communication paths between a first Relay Station (RS) and a second RS;
exchanging first control messages via a first path if the communication path between the first RS and the second RS is a direct one-hop relay link; and
exchanging second control messages via a second path if the first RS and the second RS are unable to set up the direct one-hop relay link.

5. The method of claim 4 further including exchanging, via the second path, a MAC management message HO_CPL used to inform the successful MS network attachment at a target access station over the relay links.

6. The method of claim 4 further including exchanging control messages ST_SCN-REQ/ST_SCN-RSP, HO_INFO-REQ/HO_INFO-RSP, and MS_INFO-REQ/MS_INFO-RSP via the first path.

7. The method of claim 4 wherein control messages further include using a signaling procedure to support a seamless handover of an IEEE 802.16e compliant MS.

8. The method of claim 4 wherein exchanging control messages further include selecting control message based on available paths between infrastructure stations and contents of the control messages.

9. A method using MAC message exchange for Mobile Station (MS) handover in a multi-hop relay broadband wireless access network, comprising:
exchanging control messages that differ according to an available path established between the MS and infrastructure stations in the multi-hop relay broadband wireless access network.

10. The method for handover of claim 9 further including delivering all control messages using a k-hop relay path and a wired backbone path.

11. The method for handover of claim 9 further including enabling handover for the MS from a Multi-hop Relay Base Station (MR-BS) to a Relay Station (RS) in a different MR-cell.

12. A method for Mobile Station (MS) handover in a multi-hop relay broadband wireless access network, comprising:
determining wireless resource consumption and delay for multi-hop paths between a mobile station (MS) and base stations (MR-BSs) capable of transmitting and/or receiving information via Over-The-Air (OTA) Radio Frequency (RF) links; and
delivering message exchanges between the MS and MR-BSs that differ according to an available path selected between the MS and MR-BSs in accordance with the wireless resource consumption and delay in the multi-hop relay broadband wireless access network.

13. The method for Mobile Station (MS) handover of claim 12 wherein the message exchanges include sending a MAC management message HO_CPL used to inform a successful MS network attachment over selected relay links.
